(19) United States
(12) Patent Application Publication
(10) Pub. No.: US 2014/0199594 A1
(43) Pub. Date: Jul. 17, 2014

(54) ANODE ACTIVE MATERIAL FOR SECONDARY BATTERY AND METHOD OF MANUFACTURING THE SAME

(71) Applicant: MK ELECTRON CO., LTD., Yongin-si (KR)

(72) Inventors: Soon Ho HONG, Yongin-si (KR); Jong Soo CHO, Seoul (KR); Jeong Tak MOON, Suwon-si (KR)

(73) Assignee: MK ELECTRON CO., LTD., Yongin-si (KR)

(21) Appl. No.: 13/742,619

(22) Filed: Jan. 16, 2013

(51) Int. Cl. H01M 4/38; H01M 4/04

(52) U.S. Cl. CPC H01M 4/386; H01M 4/0488
USPC 429/218.1; 252/182.1

(57) ABSTRACT

An anode active material for a lithium secondary battery having high-capacity and high-efficient charge/discharge characteristics. The anode active material includes silicon single phases; and silicon-metal alloy phases surrounding the silicon single phases. A dopant is distributed in the anode active material, and the silicon single phases are formed through rapid-cooling solidification, and the silicon single phases have a fine microstructure due to the dopant.

### BACKGROUND OF THE INVENTION

1. Field of the Invention

One or more aspects of the present invention relate to an anode active material for a secondary battery and a method of manufacturing the same, and more particularly, to an anode active material including silicon for a secondary battery and a method of manufacturing the same.

2. Description of the Related Art

Recently, use of lithium secondary batteries has been rapidly expanded to various application fields. For example, lithium secondary batteries have been used as not only power sources for portable electronic products, e.g., mobile phones and notebook computers, but also medium/large-scale power sources for hybrid electric vehicles (HEV), plug-in HEVs, and so on. As application fields have expanded and demands therefor have increased, external shapes and sizes of batteries have diversified and there is a growing need for batteries having higher capacity, an extended cycle-life, and better safety than those of conventional small-sized batteries.

In general, a lithium secondary battery is manufactured by using materials which lithium ions can be intercalated into and deintercalated from, as an anode and a cathode, forming a porous separator between the anode and the cathode, and injecting an electrolyte solution into the anode, the cathode, and the porous separator. Electric current is produced or consumed due to a redox reaction caused by intercalation/deintercalation of lithium ions in the anode and the cathode.

Graphite is an anode active material that has been widely used in the field of conventional lithium secondary batteries, and has a layered structure which lithium ions can be easily intercalated into and deintercalated from. Although graphite has a theoretical capacity of 372 mAh/g, a new electrode material that can replace graphite is required as demands for high-capacity lithium batteries have increased. Thus, research has been actively conducted on commercialization of an electrode active material that can form electrochemical alloy with lithium ions, such as silicon (Si), tin (Sn), antimony (Sb), and aluminum (Al), as a high-capacity anode active material. However, when silicon (Si), tin (Sn), antimony (Sb), aluminum (Al), or the like are electrochemically plated with lithium, the volume of the resultant structure increases or decreases during a charge/discharge process. Such a volume change deteriorates cycle characteristics of an electrode employing silicon (Si), tin (Sn), antimony (Sb), aluminum (Al), or the like as an anode active material. Furthermore, such a volume change causes cracks in a surface of the anode active material. When cracks occur repeatedly in the surface of the electrode active material, fine particles may be formed in the surface of the electrode, thereby deteriorating cycle characteristics.

### SUMMARY OF THE INVENTION

The present invention provides an anode active material for a secondary battery having a high capacity and high-efficient charge/discharge characteristics.

The present invention also provides a method of manufacturing the anode active material for a secondary battery.

The present invention provides a secondary battery including the anode active material.

According to an aspect of the present invention, there is provided an anode active material for a secondary battery, including silicon single phases; and silicon-metal alloy phases surrounding the silicon single phases, and a dopant is distributed in the anode active material, and the silicon single phases are formed through rapid-cooling solidification, and the silicon single phases have a fine microstructure due to the dopant.

The dopant may include an element that promotes amorphization of the silicon single phases.

The dopant may include an element that promotes the silicon single phases to have a fine structure.

The dopant may include an element that provides a nuclei growth site of the silicon single phases.

The dopant may include boron (B), beryllium (Be), carbon (C), sodium (Na), strontium (Sr), phosphorous (P), molybdenum (Mo), tantalum (Ta), tungsten (W), yttrium (Y), cerium (Ce), vanadium (V), lanthanum (La), or lanthanides.

The silicon single phases may be dispersed while forming an interface with the silicon-metal alloy phases.

At least a portion of the dopant may be dispersed at the interface between the silicon single phases and the silicon-metal alloy phases, in the silicon-metal alloy phases, or in the silicon single phases.

The silicon-metal alloy phases may include at least one metal selected from the group consisting of titanium, nickel, iron, manganese, aluminum, chromium, cobalt, and zinc, at about 20 to 40 at %.

The silicon single phases may have an average particle diameter of about 10 to 200 nm.

The content of the dopant may be about 0.01 to 5 wt %.

According to another aspect of the present invention, there is provided a method of manufacturing an anode active material for a secondary battery, the method including forming a molten mixture by melting at least one metal selected from the group consisting of titanium, nickel, iron, manganese, aluminum, chromium, cobalt, and zinc and silicon together, and adding a dopant to the mixture; forming a rapidly solidified structure by rapidly cooling the molten mixture to be solidified; and forming an anode active material by grinding the rapidly solidified structure. The rapidly solidified structure includes silicon single phases having a fine structure due to the dopant, and silicon-metal alloy phases in which the silicon single phases are evenly dispersed.

According to another aspect of the present invention, there is provided a secondary battery including an anode active material. The anode active material includes silicon single phases; and silicon-metal alloy phases surrounding the silicon single phases, and a dopant is distributed in the anode active material, and the silicon single phases are formed through rapid-cooling solidification, and the silicon single phases have a fine microstructure due to the dopant.

An anode active material for a secondary battery according to an embodiment of the present invention includes silicon single phases having a fine structure due to a dopant, and silicon-metal alloy phases in which the silicon single phases are dispersed. In general, since lithium ions are intercalated into silicon single phases during battery charge/discharge, the volume of the silicon single phases expand. However, since the silicon single phases have the fine structure due to the dopant, they are highly resistant to stress caused by such a volume change and may prevent cracks from occurring therein. Accordingly, a secondary battery using the anode active material has a high initial efficiency and good cycle-life characteristics.

### BRIEF DESCRIPTION OF THE DRAWINGS

The above and other features and advantages of the present invention will become more apparent by describing in detail exemplary embodiments thereof with reference to the attached drawings in which:

FIG. 1 schematically illustrates a lithium secondary battery according to an embodiment of the present invention;

FIGS. 2 and 3 schematically illustrate an anode and a cathode included in the lithium secondary battery of FIG. 1, respectively;

FIG. 4 is a flowchart illustrating a method of manufacturing an anode active material included in a lithium secondary battery according to an embodiment of the present invention;

FIG. 5 is a diagram schematically illustrating a method of forming an anode active material according to an embodiment of the present invention;

FIGS. 6A and 6B illustrate experimental examples in which results of measuring charge/discharge characteristics were measured using an anode active material according to an embodiment of the present invention;

FIG. 7 illustrates a scanning electronic microscopic (SEM) image illustrating a microstructure of a rapidly solidified structure according to an embodiment of the present invention; and

FIG. 8 is a graph showing cycle-life characteristics of experimental examples using an anode active material according to an embodiment of the present invention.

### DETAILED DESCRIPTION OF THE INVENTION

Hereinafter, exemplary embodiments of the present invention will be described in greater detail with reference to the accompanying drawings.

The present invention may, however, be embodied in many different forms and should not be construed as being limited to the embodiments set forth herein. Rather, these embodiments are provided so that this disclosure will be thorough and complete and will fully convey the concept of the invention to those of ordinary skill in the art. In the drawings, the thickness of layers and regions may be exaggerated for clarity.

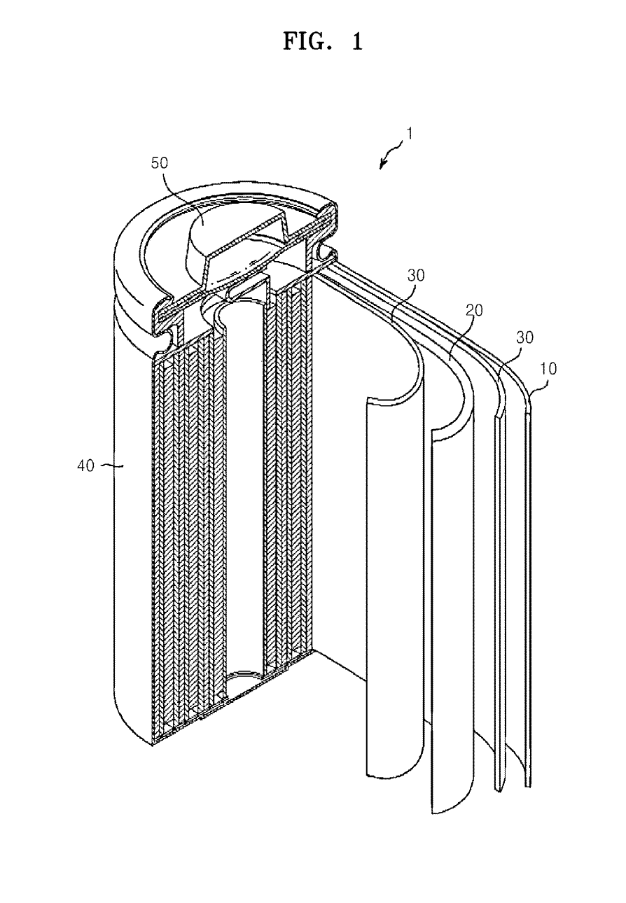

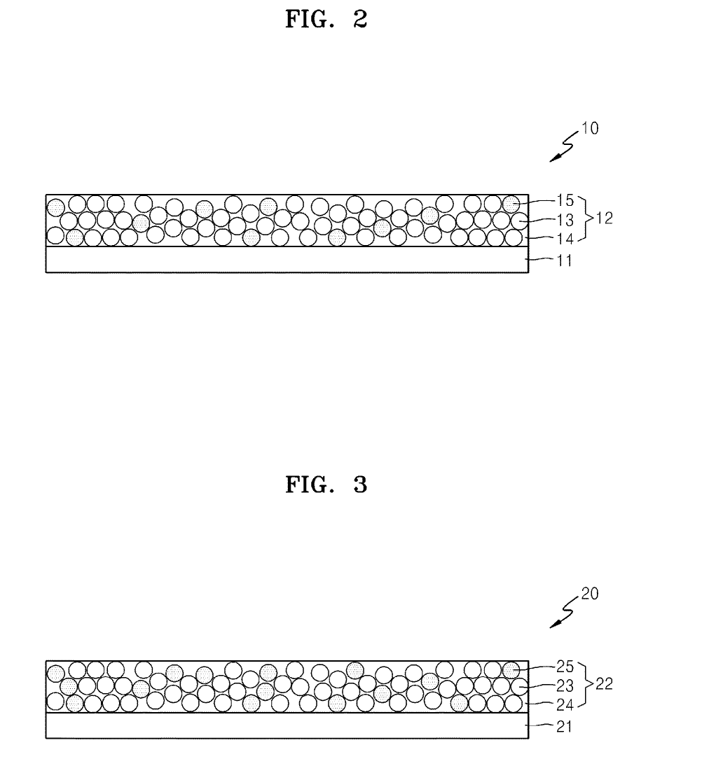

FIG. 1 schematically illustrates a secondary battery 1 according to an embodiment of the present invention. FIGS. 2 and 3 schematically illustrate an anode 10 and a cathode 20 included in the secondary battery 1 of FIG. 1, respectively.

Referring to FIG. 1, the secondary battery 1 may include the anode 10, the cathode 20, a separator 30 between the anode 10 and the cathode 20, a battery case 40, and a sealing member 50. The secondary battery 1 may further include an electrolyte (not shown) with which the anode 10, the cathode 20, and the separator 30 are impregnated. The anode 10, the cathode 20, and the separator 30 may be sequentially stacked and then be accommodated in the battery case 40 in a spirally wound state. The battery case 40 may be sealed with the sealing member 50.

The secondary battery 1 may be a lithium secondary battery using lithium as a medium, and may be classified as a lithium ion battery, a lithium ion polymer battery, or a lithium polymer battery according to the types of the separator 30 and an electrolyte. Otherwise, the secondary battery 1 may be classified as a coin type, a button type, a sheet type, a cylindrical type, a flat type, or a pouch type according to a shape, or may be classified as a bulk type or a thin film type according to a size. FIG. 1 illustrates the secondary battery 1 as a cylindrical type secondary battery but the present invention is not limited thereto.

Referring to FIG. 2, the anode 10 includes an anode current collector 11 and an anode active material layer 12 on the anode current collector 11. The anode active material layer 12 includes an anode active material 13, and an anode binder 14 that binds particles of the anode active material 13 together. Alternatively, the anode active material layer 12 may further include an anode conductive material 15. Although not shown, the anode active material layer 12 may further include an additive, such as a filler or a dispersing agent. The anode 10 may be formed by mixing the anode active material 13, the anode binder 14, and/or the anode conductive material 15 in a solvent to obtain a mixture including an anode active material, and applying the mixture on the anode current collector 11.

The anode current collector 11 may include a conductive material, e.g., a thin conductive foil. The anode current collector 11 may include, for example, copper, gold, nickel, stainless steel, titanium, or an alloy thereof. The anode current collector 11 may further include a conductive polymer. Otherwise, the anode current collector 11 may be formed by compressing an anode active material.

The anode active material 13 may include a material which lithium ions may be reversibly intercalated into/deintercalated from. According to an embodiment of the present invention, the anode active material 13 may include silicon and metal. For example, the anode active material 13 may include silicon particles dispersed in a silicon-metal matrix. The metal may be a transition metal, e.g., at least one species selected from the group consisting of Al, Cu, Zr, Ni, Ti, Co, Cr, Mn, and Fe. Each of the silicon particles may be nano-sized particles. Tin, aluminum, antimony, or the like may be used instead of silicon. The anode active material 13 will be described in detail below.

The anode binder 14 may bind the particles of the anode active material 13 together, and binds the anode active material 13 with the anode current collector 11. The anode binder 14 may be, for example, a polymer, such as polyimide, polyamideimide, polybenzimidazole, polyvinyl alcohol, carboxyl methylcellulose, hydroxypropyl cellulose, polyvinyl chloride, carboxylated polyvinyl chloride, polyvinyl fluoride, ethylene oxide, polyvinyl pyrrolidone, polyurethane, polytetrafluoroethylene, polyvinylidene fluoride, polyethylene, polypropylene, styrene-butadiene, acrylated styrene-butadiene, or epoxy resin.

The anode conductive material 15 may increase conductivity of the anode 10, and may be a conductive material that does not cause a chemical change in the secondary battery 1. For example, the anode conductive material 15 may include a carbon-based material, e.g., graphite, carbon black, acetylene black, or carbon fiber; a metal material, e.g., copper, nickel, aluminum, or silver; a conductive polymeric material, e.g., a polyphenylene derivative; or a conductive material including a mixture thereof.

Referring to FIG. 3, the cathode 20 includes a cathode current collector 21 and a cathode active material layer 22 on the cathode current collector 21. The cathode active material layer 22 includes a cathode active material 23 and a cathode binder 24 that binds particles of the cathode active material 23. Alternatively, the cathode active material layer 22 may further include a cathode conductive material 25. Although not shown, the cathode active material layer 22 may include an additive, such as a filler or a dispersing agent. The cathode 20 may be formed by mixing the cathode active material 23, the cathode binder 24, and/or the cathode conductive material 25 in a solvent to obtain a mixture including a cathode active material, and applying the mixture on the cathode current collector 21.

The cathode current collector 21 may be a thin conductive foil, and may include, for example, a conductive material. The cathode current collector 21 may include, for example, aluminum, nickel, or an alloy thereof. Otherwise, the cathode current collector 21 may be a polymer including a conductive metal. Otherwise, the cathode current collector 21 may be formed by compressing an anode active material.

The cathode active material 23 may be, for example, a cathode active material for a lithium secondary battery, and may include a material which lithium ions may be reversibly intercalated into/deintercalated from. The cathode active material 23 may include a lithium-containing transition metal oxide, a lithium-containing transition metal sulfide, or the like. For example, the cathode active material 23 may include at least one selected from the group consisting of LiCoO₂, LiNiO₂, LiMnO₂, LiMn₂O₄, Li(NiₐCo_{b}Mnₑ)O₂ (0<a<1, 0<b<1, 0<c<1, a+b+c=1), LiNi_{1-y}Co_{y}O₂, LiCo_{1-y}Mn_{y}O₂, LiNi_{1-y}Mn_{y}O₂ (0=Y<1), Li(NiₐCo_{b}Mnₑ)O₄ (0<a<2, 0<b<2, 0<c<2, a+b+c=2), LiMn_{2-z}NiₓO₄, and LiMn₂₋ₓCo_{z}O₄ (0<Z<2), LiCoPO₄, and LiFePO₄.

The cathode binder 24 may bind particles of the cathode active material 23 and also binds the cathode active material 23 with the cathode current collector 21. The cathode binder 24 may be, for example, a polymer, such as polyimide, polyamideimides, polybenzimidazole, polyvinyl alcohol, carboxylmethyl cellulose, hydroxypropyl cellulose, polyvinyl chloride, carboxylated polyvinyl chloride, polyvinyl fluoride, ethylene oxide, polyvinyl pyrrolidone, polyurethane, polytetrafluoroethylene, polyvinylidene fluoride, polyethylene, polypropylene, styrene-butadiene, acrylated styrene-butadiene, or epoxy resin.

The cathode conductive material 25 may increase conductivity of the cathode 20, and may be a conductive material that does not cause a chemical change in the secondary battery 1. For example, the cathode conductive material 25 may include a carbon-based material, e.g., graphite, carbon black, acetylene black, or carbon fiber; a metal material, e.g., copper, nickel, aluminum, or silver; a conductive polymeric material, e.g., a polyphenylene derivative; or a conductive material including a mixture thereof.

Referring back to FIG. 1, the separator 30 may be a porous material, and may be a single film or a multi-layered film including two or more layers. The separator 30 may include a polymeric material, e.g., at least one selected from the group consisting of a polyethylene-based polymer, a polypropylene-based material, a polyvinylidene fluoride-based polymer, and a polyolefin-based polymer.

The electrolyte with which the anode 10, the cathode 20, and the separator 30 are impregnated may include a non-aqueous solvent and electrolyte salt. The type of the non-aqueous solvent is not limited if it can be used for a general non-aqueous electrolyte solution. Examples of the non-aqueous solvent may include a carbonated solvent, an ester-based solvent, an ether-based solvent, a ketone-based solvent, an alcohol-based solvent, or a nonprontonic solvent. A non-aqueous solvent or a mixture of two or more non-queous solvents may be used. When the mixture of two or more non-aqueous solvents is used, a mixing ratio of the two or more non-aqueous solvents may be appropriately adjusted according to a desired performance of a battery.

The type of the electrolyte salt is not limited if it can be used for a general non-aqueous electrolytic solution. For example, the electrolyte salt may be salt having an A⁺B⁻ structure. Here, ‘A⁺’ may denote alkaline metal positive ions, e.g., as Li⁺, Na⁺, or K⁺, or a combination thereof. ‘B⁻’ may denote negative ions, e.g., PF₆⁻, BF₄⁻, Cl⁻, Br⁻, I⁻, ClO₄⁻, ASF₆⁻, CH₃CO₂⁻, CF₃SO₃⁻, N(CF₃SO₂)₂⁻, or C(CF₂SO₂)₃⁻, or a combination thereof. For example, the electrolyte salt may be lithium-based salt, e.g., at least one selected from the group consisting of LiPF₆, LiBF₄, LiSbF₆, LiAsF₆, LiN(SO₂C₂F₅)₂, Li(CF₃SO₂)₂N, LiN(SO₃C₂F₅)₂, LiC₄F₉SO₃, LiClO₄, LiAlO₂, LiAlCl₄, LiN(CₓF₂ₓ₊₁SO₂) (C_{y}F2_{y+1}SO₂), LiCl, LiI, and LiB(C₂O₄)₂. Here, ‘x’ and ‘y’ each denote a natural number.

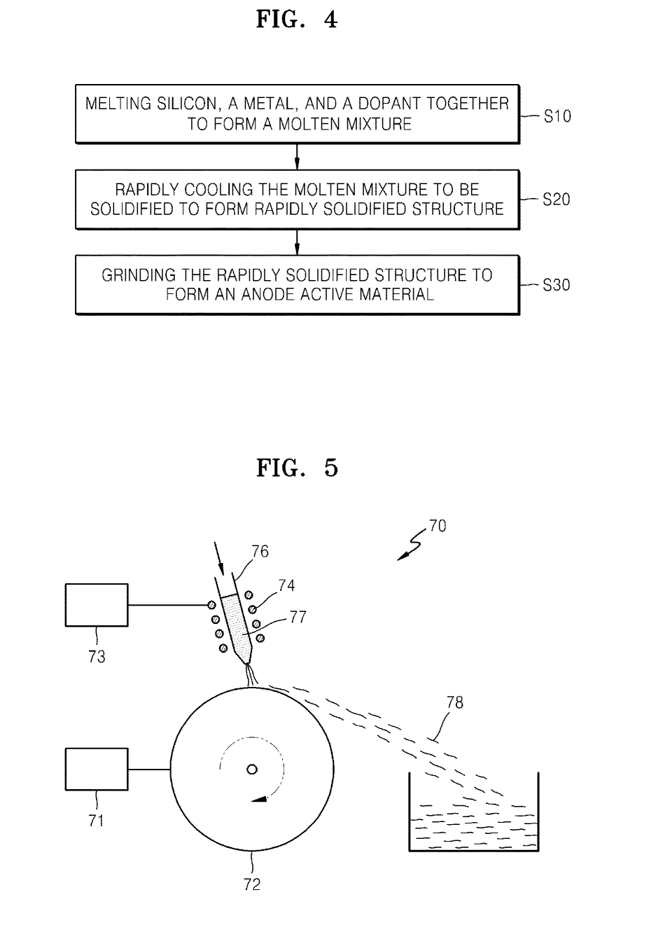

FIG. 4 is a flowchart illustrating a method of manufacturing an anode active material 13 included in a secondary battery 1 according to an embodiment of the present invention.

Referring to FIG. 4, silicon and a metal material are melted together and a dopant is added to a result of the melting, thereby forming a molten mixture (step S10). The silicon and the metal material may be melted together, for example, by generating induced heat of the silicon or the metal material through high-frequency induction using a high-frequency induction furnace. Alternatively, the molten mixture may be formed using an arc melting process.

According to an embodiment of the present invention, the metal material may include at least one selected from the group consisting of aluminum (Al), copper (Cu), zirconium (Zr), nickel (Ni), titanium (Ti), cobalt (Co), chromium (Cr), manganese (Mn), or iron (Fe). According to an embodiment of the present invention, the molten mixture may include the metal material of about 20 at % to 40 at % (atomic percent), and silicon and unavoidable impurities as a remainder. For example, the molten mixture may be formed to include silicon of about 68 at % (including the unavoidable impurities), nickel of about 16 at %, and titanium of about 16 at %.

According to an embodiment of the present invention, the dopant may include boron (B), beryllium (Be), carbon (C), sodium (Na), strontium (Sr), phosphate (P), molybdenum (Mo), tantalum (Ta), tungsten (W), yttrium (Y), cerium (Ce), vanadium (V), lanthanum (La), or lanthanides. For example, the dopant may be added at 0.01 to 5 wt % (weight percent) of the total weight of the molten mixture.

The dopant may promote silicon single phases to have a fine structure. For example, when a small amount of a dopant, e.g., sodium, strontium, antimony, phosphate, is added, grain growth of silicon single phases may be suppressed in the molten mixture, thereby obtaining silicon single phases having fine particles.

Also, the dopant may promote amorphization of silicon single phases. For example, when a small amount of the dopant, e.g., boron, beryllium, or carbon, is added, the molten mixture may be promoted to have an amorphous state. Thus, when the molten mixture in a super-cooled amorphous state is rapidly cooled to be solidified, evenly distributed silicon single phases having fine particles may be obtained. Also, the dopant added to a silicon-metal alloy may promote a martensitic transformation of the molten mixture.

In addition, the dopant may provide a nuclei growth site of silicon single phases. For example, a small amount of an element having a high melting point, such as tantalum, tungsten, or yttrium, is added as the dopant, the dopant may not be melted in the molten mixture or may be first solidified when the molten mixture is rapidly cooled. Thus, when the molten mixture is solidified in a subsequent process, the dopant may function as a nuclei growth site so that a single silicon phase adjacent to the dopant may be first nuclei-grown. Accordingly, a molten mixture including a large amount of nuclei growth site may have fine particle size and single silicon phase may be evenly formed.

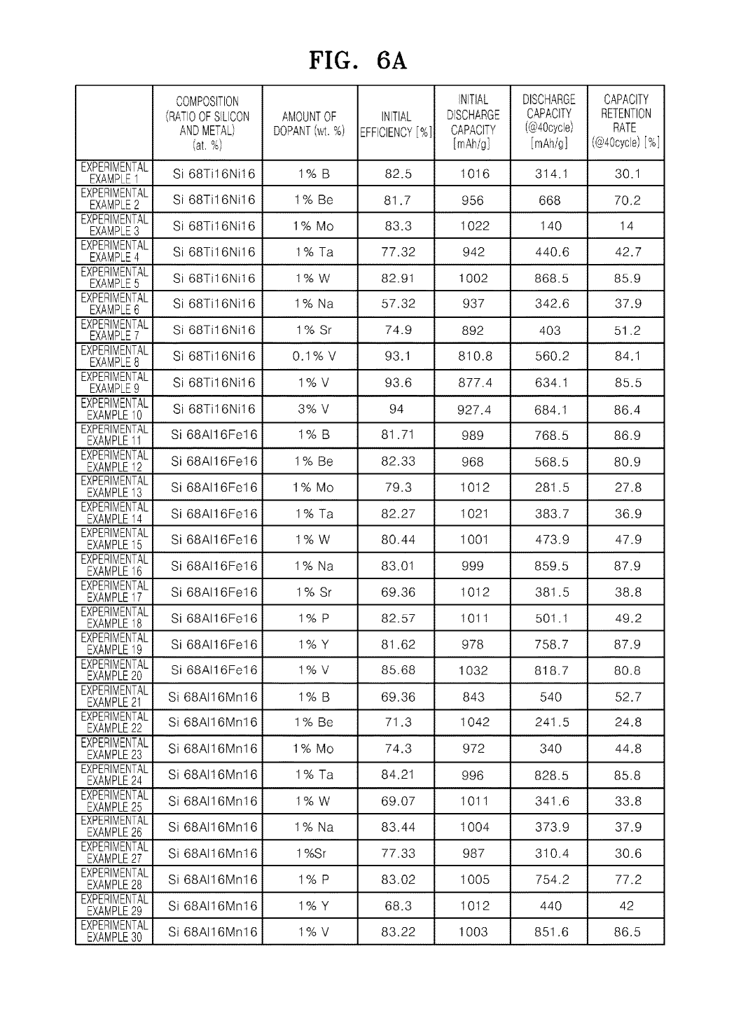

Alternatively, the dopant may include rare earth elements, e.g., yttrium, cerium, lanthanum, and lanthanides. When a small amount of lanthanides is added into an alloy, the added lanthanides may improve mechanical properties of the alloy and thermal stability thereof, thereby forming a stable interface between fine silicon single phases and silicon-metal alloy phases. Then, the molten mixture is rapidly cooled to be solidified, thus forming a rapidly solidified structure (step S20). The rapid-cooling of the molten mixture may be performed using a melt spinner illustrated in FIG. 5 and will be described in detail with reference to FIG. 5 below. However, it would be apparent to those of ordinary skill in the art that the rapidly solidified structure may be formed using another apparatus other than the melt spinner, e.g., an atomizer.

The rapidly solidified structure may include silicon single phases, silicon-metal alloy phases, and the dopant. That is, the silicon single phases of a fine size may be dispersed in a matrix of the silicon-metal alloy, and the silicon single phases may form an interface with the silicon-metal alloy. The dopant may be present at the interface between the silicon single phases and the silicon-metal alloy phases and in the silicon-metal alloy phases. Also, some of the dopant may be present in the silicon single phases.

Preferably, the content of the dopant included in the rapidly solidified structure may be about 0.01 to about 5 wt %. When the content of the dopant is less than 0.01 wt %, the amorphization of the silicon single phases may not be very effective. When, the content of the dopant is greater than 5 wt %, coarsening of the silicon single phases may occur. Then, the rapidly solidified structure is grinded to form an anode active material (step S30). The anode active material may be powder, each of particles of which has a diameter of several to several tens of micrometers. According to an embodiment of the present invention, the grinding process may be performed using any of well-known methods of grinding an alloy into powered alloy, e.g., a milling process and a ball milling process. For example, the sizes of particles of the power of the anode active material may vary depending on the duration of the ball milling process. According to an embodiment of the present invention, the ball milling process may be performed on the rapidly solidified structure for about twenty to fifty hours such that the anode active material is grinded into power having a particle diameter of several micrometers.

The anode active material may correspond to the anode active material 13 described above with reference to FIG. 1. Also, the anode 10 of the secondary battery 1 according to an embodiment of the present invention may be manufactured by mixing the anode active material with the anode binder 14 and the anode conductive material 15 to form a slurry, and applying the slurry on the anode current collector 11, as described above with reference to FIG. 1.

FIG. 5 is a schematic diagram illustrating a method of forming an anode active material according to an embodiment of the present invention.

Referring to FIG. 5, an anode active material according to an embodiment of the present invention may be formed using a melt spinner 70. The melt spinner 70 includes a cooling roll 72, a high-frequency induction coil 74, and a tube 76. The cooling roll 72 may be formed of metal that has high thermal conductivity and that is highly resistant to thermal shock, e.g., copper or a copper alloy. The cooling roll 72 may be rotated by a rotating unit 71, such as a motor, at a high speed of 1000 to 5000 rpm (revolutions per minute). The high-frequency induction coil 74 induces high frequency using a high-frequency induction unit (not shown). A cooling medium flows through the high-frequency induction coil 74 for cooling. The tube 76 may be formed of a material having low reactivity and high heat-resistant properties, e.g., quartz. Materials that are to be melted, e.g., silicon and a metal material, are inserted into the tube 76. The high-frequency induction coil 74 may be wound to surround the tube 76, and may induce high frequency to melt the materials inserted into the tube 76, thereby forming a molten mixture 77 in a liquid state or having fluidity. In this case, the tube 76 may be maintained in a vacuum state or at an inert atmosphere to prevent undesired oxidization of the molten mixture 77. When the molten mixture 77 is formed, a compressed gas (e.g., an inert gas, such as argon or nitrogen) is injected into the tube 76 at a side of the tube 76 (as indicated by an arrow), and the molten mixture 77 is discharged via a nozzle formed at another side of the tube 76 due to the compressed gas. The discharged molten mixture 77 contacts the cooling roll 72 that is rotating, and is then rapidly cooled by the cooling roll 72 to form a rapidly solidified structure 78. The rapidly solidified structure 78 may have a ribbon shape or a fragment shape. By rapidly cooling the molten mixture 77 using the cooling roll 72, the molten mixture 77 may be cooled at a high rate, e.g., at a rate of 10³ to 10⁷° C./second. The cooling rate may vary according to a speed of rotation, material, or temperature of the cooling roll 72.

Thus, when the rapidly solidified structure is formed using the melt spinner 70, silicon single phases may be rapidly precipitated in the molten mixture. Thus, the silicon single phases may be evenly dispersed in silicon-metal alloy phases while forming an interface with the silicon-metal alloy phases in the solidified structure. According to an embodiment of the present invention, when a dopant is added, the silicon single phases may be promoted to have a fine structure.

### EXPERIMENTAL EXAMPLES

1. Forming of Anode Active Material

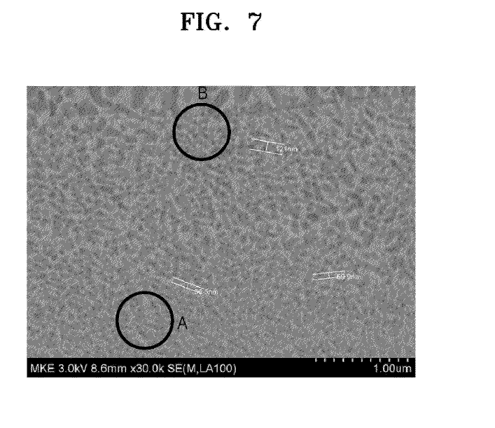

In experimental examples 1 to 60, a molten mixture of silicon-metal alloy phases of atomic percent was formed as illustrated in FIG. 7. For example, in experimental example 1, about 16 at % of titanium, about 16 at % of nickel, and about 68 at % of silicon were mixed together and about 1 wt % of boron (B) was added as a dopant to the mixture, thereby forming a molten mixture. That is, the mixture (including silicon, nickel, and titanium) is at 99 wt % and the dopant (boron) is at 1 wt % of the total weight of the molten mixture.

The molten mixture of such an atomic percent was rapidly cooled to be solidified to form a rapidly solidified structure, and the rapidly solidified structure was ball-milled for forty-eight times, thereby forming an anode active material in a power form. Thus, in the anode active material, silicon single phases are evenly dispersed in silicon-metal alloy phases. As a comparative example of the experimental examples, about 16 at % of titanium, about 16 at % of nickel, and about 68 at % of silicon were mixed to form a molten mixture to which no dopant was added.

2. Manufacture of Half-Cell

A half-cell was manufactured to evaluate electrochemical properties of the anode active material. A coin cell was manufactured using metal lithium as a reference electrode, and using an anode formed as a measurement electrode by adding a binder and a conductive material to one of the anode active materials formed according to experimental examples 1 to 60.

3. Evaluation of Charge/Discharge Characteristics

An initial discharge capacity, initial efficiency, and capacity retention rate of the half-cell were measured. In this case, a first charge/discharge cycle was performed at current density of 0.1 C, a second charge/discharge cycle was performed at current density of 0.2 C, and the other charge/discharge cycles were performed at current density of 1.0 C.

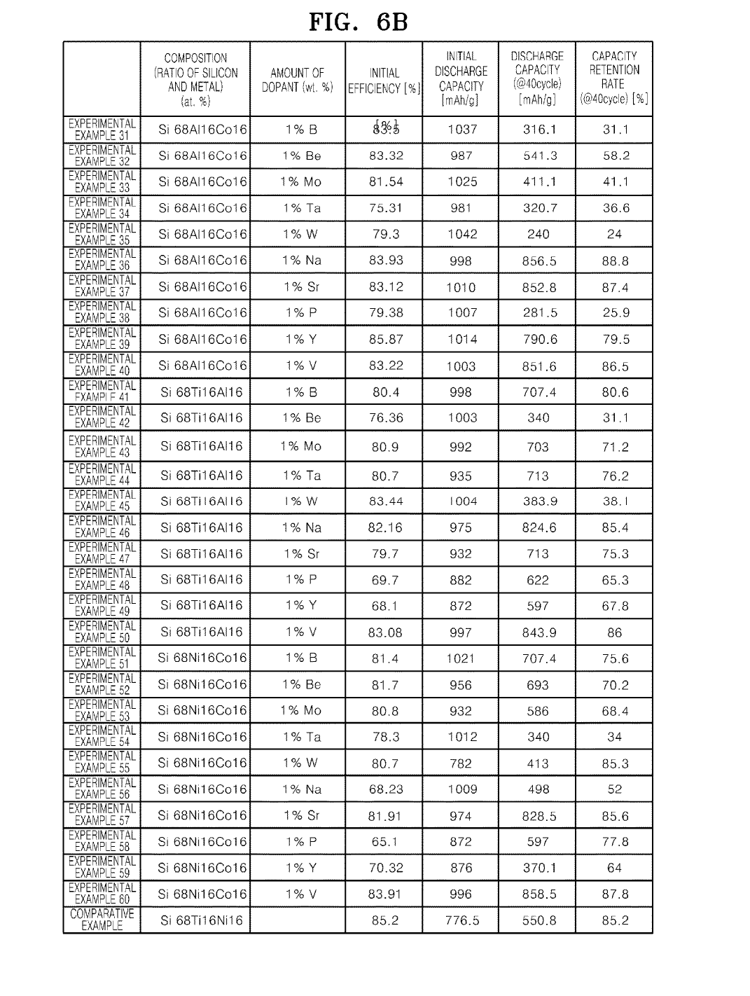

FIGS. 6A and 6B illustrate experimental examples in which results of measuring charge/discharge characteristics were measured using anode active materials according to various embodiments of the present invention. In the experimental examples, initial efficiencies (%), initial discharge capacities(mAh/g), and discharge capacities at 40^{th} cycle (mAh/g) and capacity retention rates at 40th cycle (%) are illustrated in FIGS. 6A and 6B.

FIG. 7 illustrates a scanning electronic microscopic (SEM) image illustrating a microstructure of a rapidly solidified structure according to an embodiment of the present invention. A molten mixture according to experimental example 8 was rapidly cooled, and the resultant rapidly solidified structure was observed with a magnification of about 30,000 times before it was grinded. In experimental example 8, the rapidly solidified structure was formed by mixing about 16 at % of titanium, about 16 at % of nickel, and about 68 at % of silicon, adding about 0.1 wt % of vanadium as a dopant to the mixture to form a molten mixture, and then rapidly cooling the molten mixture.

Referring to FIG. 7, in the rapidly solidified structure, silicon single phases (dark parts of the photo) were evenly distributed while forming an interface with silicon-metal alloy phases (light parts of the photo). The silicon single phases were distributed while having particles each having a size of about 10 to 200 nm. For example, the sizes of the particles of the silicon single phases were measured as about 56.5 nm, about 59.9 nm, or about 121 nm.

In FIG. 7, a region A denotes a microstructure of a region of the rapidly solidified structure, which directly contacted a cooling wheel of a melt spinner and was thus cooled, and a region B denotes a microstructure of a region of the rapidly solidified structure, which did not directly contact the cooling wheel of the melt spinner and was cooled by air. Particle sizes of silicon single phases in the region A were smaller than in the region B. The silicon single phases in the region A that contacted and cooled by a region of the cooling wheel of the melt spinner may be cooled at higher rate than those in the region B. Thus, the silicon single phases in the region A may be more finely precipitated and solidified than those in the region B. In contrast, the silicon single phases in the region B that did not contact a region of the cooling wheel of the melt spinner and contacted and cooled by air may be sufficiently grown. Thus, the silicon single phases in the region B may be larger than those in the region A.

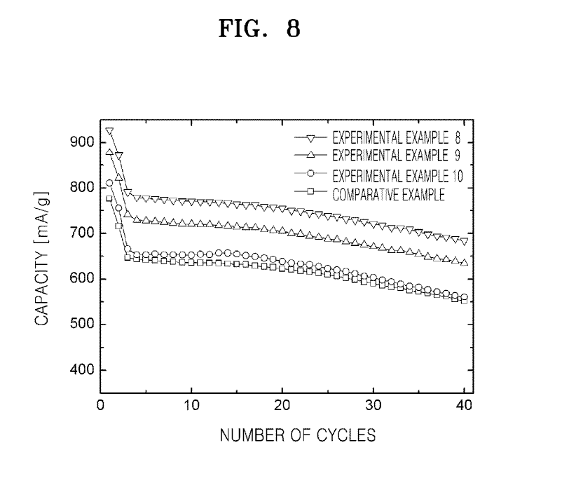

FIG. 8 is a graph showing cycle-life characteristics of experimental examples using an anode active material according to an embodiment of the present invention. In particular, FIG. 8 illustrates cycle-life characteristics of experimental examples 8 to 10 and the comparative example when charge/discharge cycle test was performed.

Referring to FIG. 8, initial capacities of battery cells using anode active materials according to experimental examples 8 to 10 were higher than that of a battery cell using an anode active material according to the comparative example. Also, battery cells including experimental examples 8 to 10 shows better cycle-life characteristics while a charge/discharge cycle was performed forty times.

Specifically, the battery cells according to experimental examples 8 to 10 had initial charge capacities of 810.8 mAh/g,877.4 mAh/g, and 927.4 mAh/g, respectively. The battery cell according to the comparative example had an initial discharge capacity of 776.5 mAh/g. Also, the battery cells according to experimental examples 8 to 10 had initial efficiencies (i.e., a ratio of the initial discharge capacity and the initial charge capacity) of 93.1%, 93.6%, and 94.0%, respectively. The battery cell according to the comparative example had an initial efficiency of 92.1%.

When a battery cell is initially charged, lithium ions are intercalated into silicon single phases in an anode active material, and the silicon single phases has a LiₓSi_{y} state. Then, when the battery cell is discharged, a reversible reaction occurs during which lithium ions deintercalated from the silicon single phases in the anode active material are intercalated into a cathode active material via an electrolyte. In this case, since an amount of the lithium ions that are initially discharged denotes an initial discharge capacity, the higher the initial discharge capacity and initial efficiency (a ratio of the initial discharge capacity to an initial charge capacity) are, the more the amount of the anode active material that may participate in the reversible reaction. According to embodiments of the present invention, since silicon single phases in an anode active material may be finely dispersed due to a dopant, surface areas of the silicon single phases that may participate in the reversible reaction may increase so that the initial discharge capacity and the initial efficiency may be increased.

During charge/discharge of a battery cell, lithium ions passing through silicon-metal alloy phases may arrive the silicon single phases. If the silicon single phases are evenly distributed, dispersion of a diffusion path of the lithium ions may be decreased (i.e., less variation of the diffusion path of lithium ions). In other words, since lithium ions may be easily delivered into the silicon single phases in the anode active material, a charge/discharge efficiency may be maintained constant. As illustrated in FIG. 7, when silicon single phases are dispersed in silicon-metal alloy phases while having uniform particle sizes, the charge/discharge efficiency may be maintained constant.

The battery cells according to experimental examples 8 to 10 showed capacity retention rates of 84.1%, 85.5%, and 86.4%, respectively, when a charge/discharge cycle was performed forty times. In this case, the capacity retention rates of the battery cells according to experimental examples 8 to 10 are similar to a capacity retention rate of the battery cell according to the comparative example, i.e., 85.2%, when a charge/discharge cycle was performed forty times. According to the present invention, since silicon single phases are finely dispersed in silicon-metal alloy phases due to a dopant, a volume change in the silicon single phases, caused when the silicon single phases expand or shrink during charge/discharge may be sufficiently avoided by a matrix of a silicon-metal alloy. That is, a resistance to stress caused by the volume change during charge/discharge may be increased due to fine silicon single phases, and cracks caused by the stress may be prevented from occurring in an anode active material. Accordingly, a battery cell using the anode active material has good charge/discharge characteristics.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An anode active material for a secondary battery, comprising:
silicon single phases; and
silicon-metal alloy phases surrounding the silicon single phases,
wherein a dopant is distributed in the anode active material, and
the silicon single phases are formed through rapid-cooling solidification, and the silicon single phases have a fine microstructure due to the dopant.

2. The anode active material of claim 1, wherein the dopant comprises an element that promotes amorphization of the silicon single phases.

3. The anode active material of claim 1, wherein the dopant comprises an element that promotes the silicon single phases to have a fine structure.

4. The anode active material of claim 1, wherein the dopant comprises an element that provides a nuclei growth site of the silicon single phases.

5. The anode active material of claim 1, wherein the dopant comprises boron (B), beryllium (Be), carbon (C), sodium (Na), strontium (Sr), phosphorous (P), molybdenum (Mo), tantalum (Ta), tungsten (W), yttrium (Y), cerium (Ce), vanadium (V), lanthanum (La), or lanthanides.

6. The anode active material of claim 1, wherein the silicon single phases are dispersed while forming an interface with the silicon-metal alloy phases.

7. The anode active material of claim 6, where at least a portion of the dopant is dispersed at the interface between the silicon single phases and the silicon-metal alloy phases, in the silicon-metal alloy phases, or in the silicon single phases.

8. The anode active material of claim 1, wherein the silicon-metal alloy phases comprise at least one metal selected from the group consisting of titanium, nickel, iron, manganese, aluminum, chromium, cobalt, and zinc, at about 20 to 40 at % (atomic percent).

9. The anode active material of claim 1, wherein the silicon single phases have an average particle diameter of about 10 to 200 nm.

10. The anode active material of claim 1, wherein a content of the dopant is about 0.01 to 5 wt %.

11. A method of manufacturing an anode active material for a secondary battery, the method comprising:
forming a molten mixture by melting at least one metal selected from the group consisting of titanium, nickel, iron, manganese, aluminum, chromium, cobalt, and zinc and silicon together, and adding a dopant to the mixture;
forming a rapidly solidified structure by rapidly cooling the molten mixture to be solidified; and
forming an anode active material by grinding the rapidly solidified structure,
wherein the rapidly solidified structure comprises silicon single phases having a fine structure due to the dopant, and silicon-metal alloy phases in which the silicon single phases are uniformly dispersed.

12. A secondary battery including an anode active material, wherein the anode active material comprises:
silicon single phases; and
silicon-metal alloy phases surrounding the silicon single phases,
wherein a dopant is distributed in the anode active material, and
the silicon single phases are formed through rapid-cooling solidification, and the silicon single phases have a fine microstructure due to the dopant.
